(19) United States
(12) Patent Application Publication
(10) Pub. No.: US 2017/0024305 A1
(43) Pub. Date: Jan. 26, 2017

(54) CLIENT APPLICATION PROFILING

(71) Applicant: HEWLETT PACKARD ENTERPRISE DEVELOPMENT LP, Houston, TX (US)

(72) Inventors: Boaz Betser, Yehud (IL); Avigall Oron, Yehud (IL)

(21) Appl. No.: 15/117,710

(22) PCT Filed: Feb. 11, 2014
(86) PCT No.: PCT/US2014/015694

§ 371 Date: Aug. 9, 2016

(51) Int. Cl. G06F 11/36

(52) U.S. Cl. CPC G06F 11/3612; G06F 11/3644

(57) ABSTRACT

In one implementation, a profiling system can comprise an instrumentation engine, a script engine, a distribution engine, and a monitor engine. The instrumentation engine can add profile functionality to a client application. The script engine can provide a test script for the synthetic client. The distribution engine can send the client application with the profile functionality to a synthetic client. The monitor engine can receive messages from the profile functionality. In another implementation, a method for profiling a client application can comprise distributing a client application to a synthetic client to execute a test script on the client application, receiving client profile information from the synthetic client, and analyzing the client profile information based on a quality threshold.

### BACKGROUND

Software can become complex in structure and interaction between modules. Software can be tested for errors in behavior, sometimes referred to as bugs. For example, software can be tested in a lab simulating possible operations of the software. Tools exist that provide analysis of code as it operates to monitor the application and discover bugs. The information from those tools can be used to improve user satisfaction and quality of service.

### BRIEF DESCRIPTION OF THE DRAWINGS

FIGS. 1 and 2 are block diagrams depicting example profiling systems.

FIG. 3 depicts example environments in which various example profiling systems can be implemented.

FIG. 4 depicts example modules used to implement example profiling systems.

FIGS. 5 and 6 are flow diagrams depicting example methods for profiling a client application.

### DETAILED DESCRIPTION

In the following description and figures, some example implementations of profiling systems and/or methods for profiling a client are described. Profiling is analysis of an application (discussed herein as a set of instructions such as a computer program) based on measurements made available by instrumentation of the application. For example, code can be injected into the program source code or the binary executable and a profiler tool (or “profiler” as used herein) can use a technique to receive and analyze the program during runtime. The instrumentation code can be aware of the profiler tool and communicate with it. Profiler tools can collect data in a variety of ways, including event-based, statistical, instrumented, and simulation techniques.

Profiler tools can provide useful information regarding application behavior. For example, a software development cycle can include profiling an application in a laboratory during the testing phase to discover latency issues. However, some behavior can be difficult to replicate in a laboratory and instrumentation of application can comes with disadvantages. Profiling can create execution overhead based on the depth of the profiling and level of instrumentation in the application code. For example, performance may be affected by 1-5% even when profiling is in an inactive state. Client-side profiling of an application can have negative effects that lead to reduced user satisfaction such as a decrease in performance. As such, quality of service (“QoS”) departments may rely solely on server-side profiling to determine root cause analysis (“RCA”). However, without client-side profiling, a complete view of the application behavior may not be possible.

Various examples described below relate to client-side profiling using a synthetic client to execute a real production scenario on an end user device. A synthetic client, as used herein, is a real device to operate as an end user device capable of executing a client application. For example, the customer can request a mobile device with same configuration as the end user device to execute the client application with profile functionality. By utilizing a synthetic client to execute a real production scenario on an end user's device, client-side profiling can be performed and avoid negative effects of reduced user satisfaction.

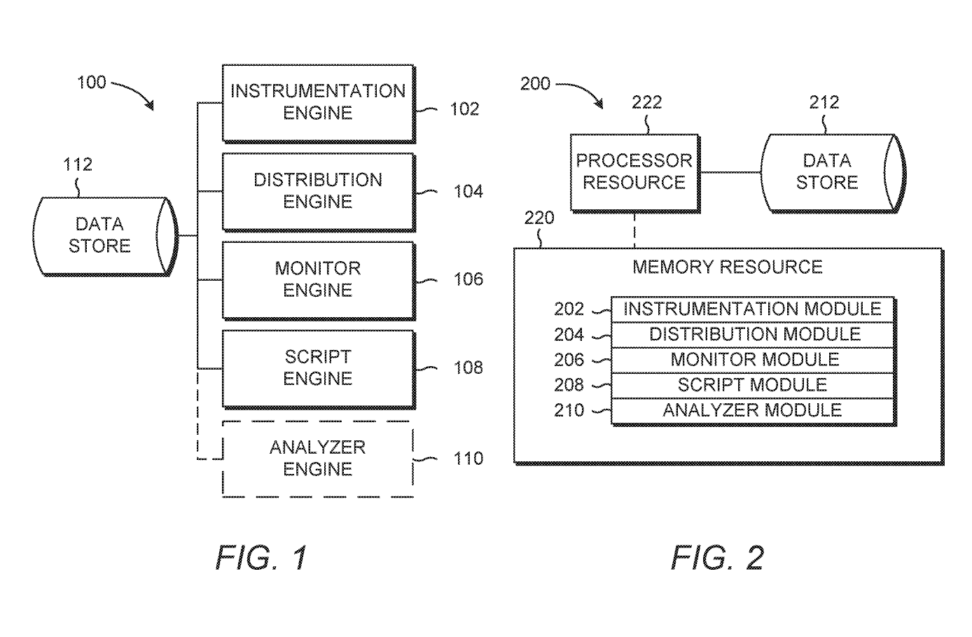

FIGS. 1 and 2 are block diagrams depicting example profiling systems. Referring to FIG. 1, an example profiling system 100 generally comprises an instrumentation engine 102, a distribution engine 104, a monitor engine 106, and a script engine 108. In general, distribution engine 104 can send a client application (that has been modified by the instrumentation engine 102 to profile the client application) and a test script to a synthetic client and the monitor engine 106 can listen for profile messages from the client application. The profiling system 100 can include an analyzer engine 110 to analyze the client application based on the profile messages and QoS terms. As used herein, the term client application refers to an application executing on the end user side (also referred to herein as “client side”) of an endpoint-to-endpoint communication. An endpoint-to-endpoint communication can include a client-server interaction or transmission between a web application and a service provided on a cloud computing environment (which may have multiple and/or distributed endpoints). The terms “include,” “have,” and variations thereof, as used herein, have the same meaning as the term “comprise” or appropriate variation thereof. Furthermore, the term “based on”, as used herein, means “based at least in part on.” Thus, a feature that is described as based on some stimulus can be based only on the stimulus or a combination of stimuli including the stimulus.

The instrumentation engine 102 represents any combination of circuitry and executable instructions to add profile functionality to a client application. Profile functionality is the ability for an application to be measured based on profiling techniques. For example, a profiling tool can profile an application that is instrumented to track or trace the objects and functions of the application as the application executes. Profiling techniques, as discussed above, include inserting profiling code into source code or byte code to measure and record performance and operations of the application at runtime. Profiling, as used herein, is collecting data and measurements of the operations of an application. Profiling is distinct from measurements by third party observations of the system in detail and types of measurements available by adding instrumentation code into the application to communicate with a profiler. For example, profiling functionality can trace and track not just function call duration and other time-based associations, but also memory used, function call frequency, and function call dependency.

The distribution engine 104 represents any combination of circuitry and executable instructions to distribute, send, or otherwise communicate the client application with the profile functionality to a synthetic client. The synthetic client can operate as an end user device and execute the client application to communicate with a server. The client application, on the synthetic client, can communicate with the server in the same fashion as the client application communicates on an end user device.

The distribution engine 104 can communicate the client application to a synthetic client based on geographic location or vendor network. For example, the distribution engine 104 can send the client application to a synthetic client to test the interaction with the production server from a determined geographic location. The distribution engine 104 can communicate the client application to synthetic clients in multiple geographic locations and/or networks owned by various vendors. For example, the distribution engine 104 can distribute client applications to a plurality of synthetic clients located in various countries having a market for the customer to test the client application in those markets. For another example, the distribution engine 104 can distribute client applications to a plurality of synthetic clients operating on various vendors' networks on which end users are expected to execute the client application. The distribution engine 104 can communicate the client application to synthetic clients operating with various system configurations. For example, the distribution engine 104 can distribute the client application to a plurality of synthetic clients operating various operating systems and/or versions of operating systems to test the client application for troubleshooting and/or performance issues.

The monitor engine 106 represents any combination of circuitry and executable instructions to listen for, or otherwise receive, messages from the profile functionality. The monitor engine 106 can receive a message from a synthetic client while the client application executes and/or interacts with the server. The monitor engine 106 can receive a message from the synthetic client during or after the synthetic client executes a test script to test the client application. A message from the synthetic client can contain profile information, as discussed below.

The monitor engine 106 can receive profile information associated with the client application. The monitor engine 106 can receive the profile information from an instrumentation component executing the client application on the synthetic client. For example, a browser can execute a script and a plug-in to the browser can receive, record, and/or transmit the profile information to be received by the monitor engine 106. For another example, the instrumentation component can connect with a cloud service to report the profile information or otherwise make it available to the monitor engine 106. The instrumentation component can provide profile functionality associated with the client application and communicate profile information. The profile functionality can include an operation to produce various forms of profile information. For example, the profile functionality can include an operation to produce a call graph of a plurality of routines executed by the client application. The profile information can include a call graph and a stream of recorded events. Other profile in, a benchmark, memory location, and/or call graph data. The profile information can be associated with the execution of the test script on the synthetic client.

The monitor engine 106 can measure the profile information via a program object of the instrumentation component. For example, a program object to report profiling data can be instrumented into the client application, and the program object can report the profile functionality to the monitor engine 106. For another example, the client application can execute in a browser having profiling capability, such as a profiler plug-in, that can measure and/or send profile information as the client application executes.

The monitor engine 106 can listen for, or otherwise monitor, the profile functionality based on a profile granularity. For example, a profiler plug-in for a browser can have a granularity setting that determines what is reported to the monitor engine 106. The profile granularly can represent a unit of code to measure. For example, the monitor engine 106 can receive a profile granularity that designates to measure the profile functionality at the individual function call level.

The script engine 108 represents any combination of circuitry and executable instructions to provide a test script for the synthetic client. The test script can trigger the profile functionality on the client application. The test script can be based on a real production scenario of the client application on an end user device. For example, the customer can record a test on an end user device and the script engine 108 can provide the test script to be communicated via the distribution engine 104 to a synthetic client to execute the client application based on the test script. The test script can be generated by a customer based on a real production scenario where a real production scenario is a real end user's interactions with the client application. For example, the customer can record actions with the client application into a test script during expected use of the client application on a network, and the test script can be distributed with the client application to a synthetic client. A network, including a vendor network, can be any appropriate network, or part of a network, expected to be used by a real end user to operate the client application and communicate with the associated production servers.

The script engine 108 can record a test script based on a real production scenario of an end user device. For example, the script engine 108 can execute as a cloud service that when accessed by a user, can be used to record interactions with the device. The recording can then be distributed to synthetic clients via the script engine 108 as a test script.

The analyzer engine 110 represents any combination of circuitry and executable instructions to compare a profile message to a quality threshold. For example, the QoS terms of service can set a quality threshold of a maximum latency time for completion of a network request; if the profile message indicates a network request completed after the maximum latency time, then it would not achieve the quality threshold. The quality threshold can be a label, number, percentage, or other attribute to represent a QoS measurement. The analyzer engine 110 can analyze the profile information via a cloud service accessible from multiple synthetic clients. For example, the cloud service may receive profile information from a synthetic client and provide analysis of profile information for a user of the cloud service. The analyzer engine 110 can generate an analysis of the profile information, such as measurements related to latency, dependency, and resource use. The analysis can be made available to a customer to identify an anomaly, such as a bug, error, or other complication in application behavior. The analysis can be used to determine a solution to produce an update to the client application or improve troubleshooting of the client application.

The analyzer engine 110 can produce a call graph of a plurality of routines executed by the client application based on the profile messages received by the monitor engine 106. The analyzer engine 110 can compare the call graph of the client application with information associated with server-side of the set of transactions, such as a call graph of the server application. The analyzer engine 110 can provide a complete, end-to-end view of the entire behavior by utilizing profile information from both the client side and server side.

The data store 112 can store data used by or otherwise associated with the system 100. Specifically, the data store 112 can store data used or produced by the engines 102, 104, 106, 108, and 110 of the system 100. For example, the data store 110 can include data associated with the client application, profile information, a test script, and/or a synthetic client.

FIG. 2 depicts the example profiling system 200 can be implemented on a memory resource 220 operatively coupled to a processor resource 222. The processor resource 222 can be operatively coupled to a data store 210. The data store 210 can be the same as data store 110 of FIG. 1.

Referring to FIG. 2, the memory resource 220 can contain a set of instructions that are executable by the processor resource 222. The set of instructions can implement the system 200 when executed by the processor resource 222. The set of instructions stored on the memory resource 220 can be represented as an instrumentation module 202, a distribution module 204, a monitor module 206, a script module 208, and an analyzer module 210. The processor resource 222 can carry out a set of instructions to execute the modules 202, 204, 206, 208, and 210, and/or any other appropriate operations among and/or associated with the modules of the system 200. For example, the processor resource 222 can carry out a set of instructions to add profile functionality to a client application, communicate the client application and a test script to a synthetic client, receive profile information associated with the client application, and analyze the profile information via the cloud service. The instrumentation module 202, the distribution module 204, the monitor module 206, the script module 208, and the analyzer module 210 represent program instructions that when executed function as the instrumentation engine 102, the distribution engine 104, the monitor engine 106, the script engine 108, and the analyzer engine 110 of FIG. 1, respectively.

The processor resource 222 can be one or multiple central processing units (“CPU”) capable of retrieving instructions from the memory resource 220 and executing those instructions. Such multiple CPUs can be integrated in a single device or distributed across devices. The processor resource 222 can process the instructions, serially, concurrently, or in partial concurrence, unless described otherwise herein.

The memory resource 220 and the data store 210 represent a medium to store data utilized by the system 200. The medium can be any non-transitory medium or combination of non-transitory mediums able to electronically store data, such as modules of the system 200 and/or data used by the system 200. For example, the medium can be a storage medium, which is distinct from a transmission medium, such as a signal. The medium can be machine readable, such as computer readable. The memory resource 220 can be said to store program instructions that when executed by the processor resource 222 implements the system 200 in FIG. 2. The memory resource 220 can be integrated in the same device as the processor resource 222 or it can be separate but accessible to that device and the process resource 222. The memory resource 220 can be distributed across devices. The memory resource 220 and the data store 210 can represent the same physical medium or separate physical mediums. The data of the data store 210 can include representations of data and/or information mentioned herein, such as test scripts, profile measurements, and call graphs.

In the discussion herein, the engines 102, 104, 106, 108, and 110 of FIG. 1 and the modules 202, 204, 206, 208, and 210 of FIG. 2 have been described as a combination of circuitry and executable instructions. Such components can be implemented in a number of fashions. Looking at FIG. 2, the executable instructions can be processor executable instructions, such as program instructions, stored on the memory resource 220, which is a tangible, non-transitory computer readable storage medium, and the circuitry can be electronic circuitry, such as processor resource 222, for executing those instructions.

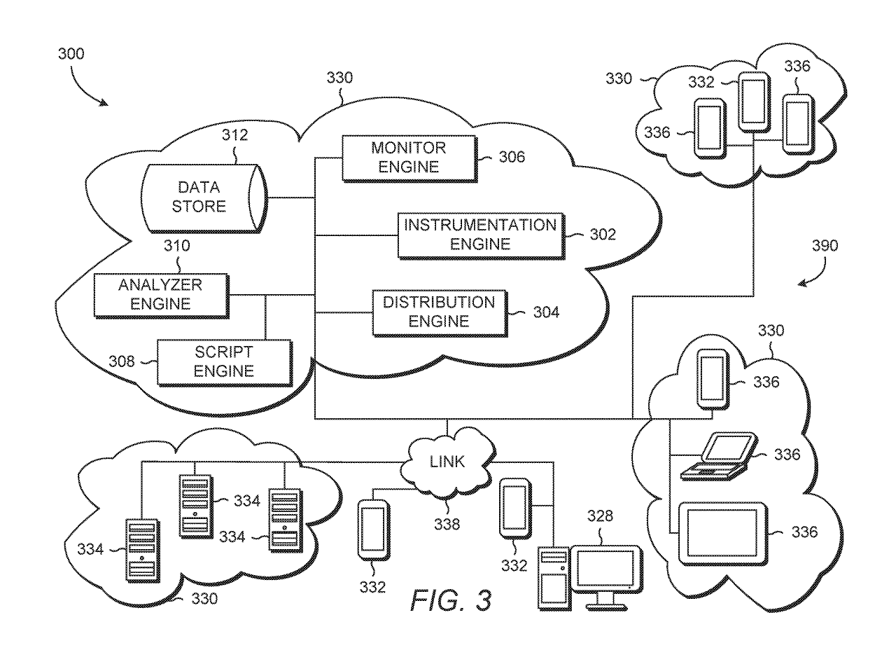

In one example, the executable instructions can be part of an installation package that when installed can be executed by processor resource 222 to implement the system 200. In that example, the memory resource 220 can be a portable medium such as a compact disc, a digital video disc, a flash drive, or memory maintained by a computer device, such as server device 334 of FIG. 3, from which the installation package can be downloaded and installed. In another example, the executable instructions can be part of an application or applications already installed. Here, the memory resource 220 can include integrated memory such as a hard drive, a solid state drive, or the like.

FIG. 3 depicts example environments 390 in which various example profiling systems 300 can be implemented. The example environment 390 is shown to include an example profiling system 300. The system 300 (described herein with respect to FIGS. 1 and 2) can represent generally any combination of circuitry and executable instructions to profile a client application. The system 300 can include an instrumentation engine 302, a distribution engine 304, a monitor engine 306, a script engine 308, an analyzer engine 310, and a data store 312 that are the same as the instrumentation engine 102, a distribution engine 104, a monitor engine 106, a script engine 108, the analyzer engine 110, and a data store 112 of FIG. 1, respectively, and the associated descriptions are not repeated for brevity.

The example system 300 can be accessed by a customer device 328. For example, the customer device 328 can submit a client application, which interacts with a server device 334, to the system 300. The system 300 can communicate the client application to a synthetic client device 336. The synthetic client 336 can operate the client application as an end user device 332 would operate the client application. For example, a test script based on a production scenario produced on an end user device 332 can be sent to a synthetic client device 336 to execute the client application based on the test script. The synthetic client 336 can execute the client application and provide profile messages to the system 300. For example, the synthetic clients 336 of a network 330 can execute a test script to perform operations of the client application and profile messages can be sent to the system 300 from the synthetic client device 336 as the client application interacts with the server application executing on a server device 334. A user, such as a customer, can access the system 300 or otherwise receive the profile information provided by the synthetic clients 336. The user can receive an analysis of the profile information as well.

The example system 300 can be integrated into a compute device, such as a customer device 328, an end user device 332, a server device 334, or a synthetic client device 336. The system 300 can be distributed across customer devices 328, end user devices 332, server devices 334, synthetic client devices 336, or a combination of customer devices 328, end user devices 332, server devices 334, and synthetic client devices 336. The environment 390 can include a cloud computing environment. For example, networks 330 can be distributed networks comprising virtual computing resources. Any appropriate combination of the system 300, customer devices 328, end user devices 332, server devices 334, and synthetic client devices 336 can be a virtual instance of a virtual shared pool of resources. The synthetic client devices 336 operate as the end user devices 332. For example, if an end user device 332 is a real, physical device then the test script is to be performed on a real, physical synthetic client device 336. This can allow for real behavior to be produced rather than behavior created in a test lab. The engines and/or modules of the system 300 herein can reside and/or execute on the cloud. The example environment 390 can include multiple cloud computing networks, such as networks 330. The networks 330 can be located in distinct geographic locations. For example, a network 330 with synthetic client devices 336 can be located in a geographic location different from the end user devices 332. The networks 330 can be provided by distinct network vendors. For example, a first synthetic client device 336 can communicate via a first network 330 provided by a first vendor distinct from a second vendor providing a second network 330 for communications of a second synthetic client device 336. A customer can select a synthetic client device 336 to use based on an environment configuration on which an end user is expected to operate the client application. For example, a synthetic client device 336 can operate on the same network 330 as end user device 332. The customer can select a representation of networks 330 and/or geographic locations on which end user devices 332 are expected to operate.

In the example of FIG. 3, a synthetic client device 336 can replicate, or otherwise operate as, an end user device 332. For example, an end user device 332 can be a particular mobile phone with a particular configuration on a particular network 330 and the synthetic client device 336 can be the same model of mobile phone with the same configuration connected to the same network 330. In this way, the synthetic client device 336 can operate as the end user device 332 to profile the client application while the end user device can avoid the disadvantages associated with executing a client application with profile functionality, such as application latency.

The server devices 334 represent generally any computing devices configured to respond to a network request received from a customer's end user device 332, or synthetic client device 336, whether virtual or real. For example, a server device 332 can be a virtual machine of the network 330 providing a service and the end user device 332 can be a compute device configured to access the network 330 and receive and/or communicate with the service. A server device 334 can include a webserver, an application server, or a data server, for example. The end user devices 332 represent generally any compute device configured with a browser or other application to communicate a network request and receive and/or process the corresponding responses. The end user devices 332 can be configured to execute the client application to communicate with the server device 334. The synthetic client device 336 is a separate device from the end user device 332, but otherwise can operate the same as the end user device 336. For example, if a customer intends an end user to operate a tablet device with a particular operating system, the synthetic client device 336 can be that particular model of tablet device with the particular operating system and execute from a different location, such as a distinct internet protocol (“IP”) address.

A link 338 represents generally one or any combination of a cable, wireless connection, fiber optic connection, or remote connections via a telecommunications link, an infrared link, a radio frequency link, or any other connectors of systems that provide electronic communication. The link 338 can include, at least in part, intranet, the Internet, or a combination of both. The link 338 can also include intermediate proxies, routers, switches, load balancers, and the like.

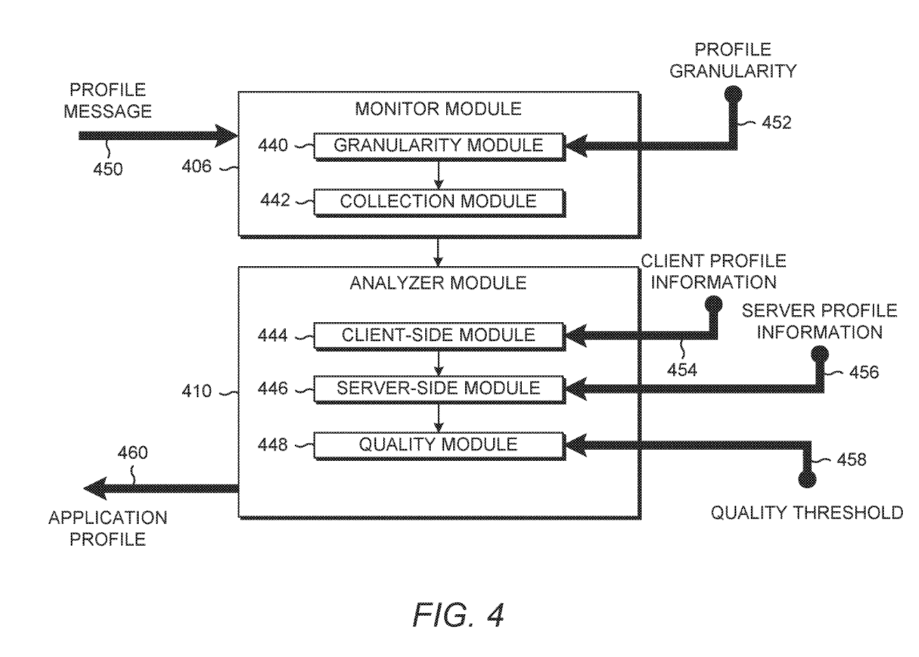

Referring to FIGS. 1-3, the engines 102, 104, 106, 108, and 110 of FIG. 1, and/or the modules of 202, 204, 206, 208 and 210 of FIG. 2 can be distributed across customer devices 328, end user devices 332, server devices 334, synthetic client devices 336, other devices or storage mediums, or a combination thereof. The engines and/or modules can complete or assist completion of operations performed in describing another engine and/or module. For example, the distribution engine 304 of FIG. 3 can request, complete, or perform the methods and/or operations of the distribution engine 304 as well as the monitor engine 306, the script engine 308, and the analyzer engine 310. The engines and/or modules of the system 400 can perform the example methods described in connection with FIGS. 4-6.

FIG. 4 depicts example modules used to implement example profiling systems. The example modules of FIG. 4 generally include a monitor module 406 and an analyzer module 410, which can be the same as the monitor module 206 and the analyzer module 210 of FIG. 2, respectively. As depicted in FIG. 4, the example monitor module 406 can include a granularity module 440 and a collection module 442, and the example analyzer module 410 can include a client-side module 444, a server-side module 446, and a quality module 448. The monitor module 406 can receive a profile message 450 from a synthetic client. The monitor module 406 can provide the profile information to the analyzer module 410. The analyzer module 410 can analyze the profile information received by the profiling system and provide the application profile 460, such as an end-to-end report of behavior between a client application (such as a web application) and a server application (such as an service application executing on a distributed computing environment to interact with the web application).

The granularity module 440 represents program instructions that when executed function as a combination of circuitry and executable instructions to receive a profile granularity 452. The profile granularity 452 can be any appropriate unit of code to determine the level of precision of the profiler. For example, the profile granularity 452 can range from the level of an individual function or line of code to blocks of code or component level measurements.

The collection module 442 represents program instructions that when executed function as a combination of circuitry and executable instructions to collect the profile information from the profile message. For example, the collection module 442 can obtain the profile information from a plurality of profile messages associated with the execution of a test script to produce an application profile associated with execution of a client application. The collection module 442 can collect profile information from a plurality of synthetic clients. For example, the collection module 442 can aggregate client profile information 454 from a plurality of synthetic clients.

The analyzer module 410 can receive profile information and profile the application based on the profile information. For example, the analyzer module 410 can identify an anomaly of the behavior of the client application based on the profile information. The client-side module 444 represents program instructions that when executed function as a combination of circuitry and executable instructions to receive client profile information 454 from a client application.

The analyzer module 410 can utilize profile information from the server application to complete a perspective of the behavior of the client application. The server-side module 446 represents program instructions that when executed function as a combination of circuitry and executable instructions to receive server profile information 456 from a server application. The analyzer module 410 can aggregate server profile information 456 from a plurality of server applications.

The analyzer module 410 can identify an anomaly, such as a failure to meet QoS terms, based on a quality threshold 458. The quality module 448 represents program instructions that when executed function as a combination of circuitry and executable instructions to associate the client profile information and the server profile information and analyze the combined profile information with a quality threshold 458. The quality threshold 458 can be determined by a service level agreement (“SLA”) or other source related to terms of QoS.

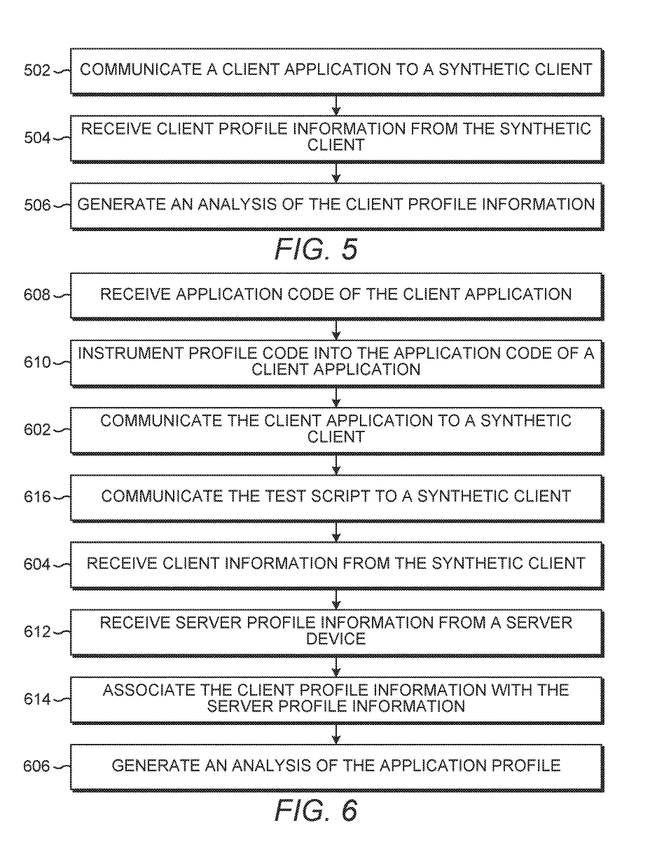

FIGS. 5 and 6 are flow diagrams depicting example methods for profiling a client application. Referring to FIG. 5, example methods for profiling a client application can generally comprise distributing a client application to a synthetic client, receiving client profile information from the synthetic client, and analyzing the client profile information.

At block 502, a client application is communicated to a synthetic client. The client application can be distributed to a plurality of synthetic clients. The synthetic clients can be located on various networks. The synthetic client can operate the client application to communicate with a server application over a network, such as a vendor network, and to profile the client application during operation. The synthetic client can execute a test script to operate the client application to trigger communication with the server application in the same fashion as an end user device. For example, the test script can execute a real production scenario of the client application as performed on an end user device.

The client application can be distributed, or otherwise communicated, to a plurality of synthetic clients. The synthetic clients can test the plurality of synthetic clients based on a test script. The test script can be executed on the plurality of synthetic clients to test execution of the client application in an end-user environment. For example, the client application can be executed on a plurality of synthetic clients to test an end user's experience with the client application in at least one of a plurality of geographic locations and over a plurality of vendor networks. The plurality of synthetic clients can be located in a plurality of geographic locations, and the client application can be executed on the plurality of synthetic clients to test the operation of the client application at the plurality of geographic locations. The plurality of synthetic clients can be connected to a plurality of vendor networks, and the customer can select a plurality of vendor networks to test the operation of the client application over the plurality of vendor networks. The plurality of synthetic clients can include a plurality of device configurations. The client application can be executed on the plurality of synthetic clients to test the operation of the client application on a plurality of device configurations. For example, the plurality of device configurations can be various mobile device configurations.

At block 504, client profile information is received from the synthetic client. The synthetic client can execute a profile-compatible application component capable of triggering instrumentation code and providing the profile information. For example, the synthetic client can execute the client application on a browser with a profiler plug-in capable of utilizing the instrumentation code to profile the client application and provide that profile information to a monitor engine and/or analysis engine, such as monitor engine 106 and analyzer engine 110 of FIG. 1. The profile information can be generated based on execution of the instrumentation code as the client application operates, such as operations based on a test script.

At block 506, an analysis of the client profile information is generated. The analysis generated can relate to the profile information of the client application behavior and/or the complete behavior profile between the client application operations and the server application operations. For example, an analysis of the application profile can be generated to classify the behavior of the application, which includes behavior of the client application and the server application. The client profile information can be analyzed based on server profile information and/or a quality threshold. The client profile information can be analyzed to identify an anomaly. An anomaly can be latency, an error, or other characteristic associated with terms of QoS. An anomaly can be identified based on the client profile information, the server profile information, the relationship between the client profile information and the server profile information, and a quality threshold. For example, an association between the client profile information and the server profile information can indicate the failure to achieve a quality threshold is based on the latency of the client routine or server routine associated at the time of the anomaly. Associations between client profile information and server profile information are discussed in more detail in the description of block 614 of FIG. 6.

FIG. 6 includes blocks similar to blocks of FIG. 5 and provides additional blocks and details. In particular, FIG. 6 depicts additional blocks and details generally regarding receiving application code, instrumenting profile code into the application code, distributing a test script, receiving server profile information from a server, and associating the client profile information and the server profile information. Blocks 602, 604, and 606, are the same as blocks 502, 504, and 506 of FIG. 5 and their respective descriptions have not been repeated for brevity.

At block 608, application code of a client application is received. The application code can be source code or byte code capable of instrumentation. The application code is injected, or otherwise instrumented, with profile code at block 610. For example, profiling breakpoints can be added between each line of application code and instrumentation code can be inserted at each line of application code to communicate measurements to a profiler. The profile code can add profile functionality to the client application or otherwise provide instrumentation capabilities.

At block 616, a test script is communicated to a synthetic client. The test script can test the client application by executing actions of the client application based on a real end user scenario. Executing a real end user scenario can activate the profile functionality and produce profile information related to the real end user scenario. Thus, real end user data of behavior of the client application can be produced on a device other than the end user device, such as a synthetic client device.

At block 612, server profile information is received from a server device to execute a server application. The server application can communicate with the client application as the client application performs the operations of the test script on the synthetic client. The server profile information is profile information on the server-side of communications between the client application and server application. The profile information can be created as the server device executes the server application.

At block 614, the client profile information is associated with the server profile information. For example, a client routine can be associated with a server routine based on an identifier provided by the profile functionality. The client profile information and the server profile information can be associated based on an event, a time stamp, correlation between client call graph and server call graph, or other relationship among data of the client profile information and server profile information. For example, the client call graph can determine a client routine has a first identifier that is associated with a second identifier associated with a server routine of a server call graph produced based on the server profile information. With both the client side profile and the server side profile, the entire application profile information is available to be analyzed to provide a complete view of the functionality of the client application.

Although the flow diagrams of FIGS. 4-6 illustrate specific orders of execution, the order of execution may differ from that which is illustrated. For example, the order of execution of the blocks may be scrambled relative to the order shown. Also, the blocks shown in succession may be executed concurrently or with partial concurrence. All such variations are within the scope of the present invention.

The present description has been shown and described with reference to the foregoing examples. It is understood, however, that other forms, details, and examples may be made without departing from the spirit and scope of the invention that is defined in the following claims.

What is claimed is:

1. A profiling system comprising:
an instrumentation engine to add profile functionality to a client application, the client application to communicate with a server;
a script engine to provide a test script for the synthetic client, the test script to trigger the profile functionality of the client application based on a real production scenario of the client application on the end user device;
a distribution engine to communicate the client application with the profile functionality and the test script to a synthetic client, the synthetic client being a real device to operate as an end user device and execute the client application to communicate with the server; and
a monitor engine to receive messages from the profile functionality.

2. The profiling system of claim 1, wherein the profile functionality includes an operation to produce a call graph of a plurality of routines executed by the client application.

3. The profiling system of claim 2, wherein the synthetic client executes the client application to test the interaction with the production server from a determined geographic location.

4. The profiling system of claim 1, wherein the messages received by the monitor engine include a message from a server application having profile functionality, the messages to include profile information from the client application and the server application.

5. The profiling system of claim 1, comprising:
an analyzer engine to compare a profile message from the client application to a quality threshold.

6. A computer readable medium comprising a set of instructions executable by a processor resource to:
add profile functionality to a client application, the client application to communicate with a server application;
communicate the client application and a test script to a synthetic client, the test script generated by a customer based on real production scenario of the client application on an end user device and the synthetic client to operate as the end user device;
receive profile information associated with the client application from an instrumentation component executing the client application on the synthetic client based on the test script; and
generate an analysis of the profile information based on a quality threshold.

7. The medium of claim 6, wherein the set of instructions is executable by the processor resource to:
measure the profile information via a program object of the instrumentation component.

8. The medium of claim 6, wherein the profile information includes a call graph and a stream of recorded events.

9. The medium of claim 6, wherein the set of instructions is executable by the processor resource to:
receive a profile granularity to represent a unit of code to measure.

10. The medium of claim 6, wherein the set of instructions is executable by the processor resource to:
record the test script based on the real production scenario of the end user device.

11. A method for profiling a client comprising:
communicating a client application to a synthetic client, the synthetic client to execute a test script to operate a client application as an end user device to trigger communication with a server application and the test script to execute a real production scenario of the client application;
receiving client profile information from the synthetic client, the synthetic client to execute a profile-compatible application component capable of triggering instrumentation code based on the test script; and
generating an analysis of the client profile information based on a quality threshold.

12. The method of claim 11, comprising:
receiving the server profile information from a server device to execute the server application;
associating a server routine of the server profile information with a client routine of a call graph of the client profile information; and
identifying an anomaly based on the client profile information, the server profile information, a relationship between the server routine and the client routine, and the quality threshold.

13. The method of claim 11, comprising:
receiving application code of the client application; and
instrumenting profile code into the application code to add profile functionality to the client application.

14. The method of claim 11, comprising:
communicating the client application to a plurality of synthetic clients; and
communicating the test script to the plurality of synthetic clients.

15. The method of claim 15, comprising:
testing, via executing the client application on the plurality of synthetic clients, at least one of a plurality of geographic locations and a plurality of vendor networks.
